(19) United States
(12) Patent Application Publication
(10) Pub. No.: US 2025/0168194 A1
(43) Pub. Date: May 22, 2025

(54) Mitigation of Volumetric Attacks With Controlled Traffic Spreading and Load Balancing

(71) Applicant: Akamai Technologies, Inc., Cambridge, MA (US)

(72) Inventors: Russell White, Louisville, TN (US); John Leddy, Pompano Beach, FL (US)

(21) Appl. No.: 18/516,364

(22) Filed: Nov. 21, 2023

(51) Int. Cl. H04L 9/40

(52) U.S. Cl. CPC H04L 63/1441; H04L 63/1416

(57) ABSTRACT

Techniques for managing inbound traffic and/or mitigating volumetric attacks are disclosed. A preparatory phase can involve configuring an IP addressing scheme to associate multiple infrastructure deployments with a group of anycasted IP prefixes, and advertising each of those anycasted IP prefixes as reachable from each deployment. A DNS server answers queries for a domain name with an IP address from one of the IP prefixes in the group, preferably selecting such that each anycast IP prefix gets substantially equal share of the load. An attack mitigation phase can involve defending against an attack by removing the IP prefix that is under attack from the group of anycasted IP prefixes, among other things. In another embodiment, a group of several IP addresses from a single IP prefix is used, with the DNS selecting amongst the IP addresses to spread the load.

### BACKGROUND

### Technical Field

This application generally relates to managing inbound traffic load, such as that caused by volumetric attacks.

### Brief Description of the Related Art

It is known in the art to handle network traffic by deploying multiple instances of network infrastructure to distribute and share the overall load. Known request routing techniques can be used to direct clients to one of the deployments. Request routing systems include Anycast, DNS, policy based routing, among others.

Anycast is a decades-old technique for routing packets on the Internet. Anycast involves announcing the same service using the same IP address prefix, such as a /24, from multiple locations. At each location is a data center, server cluster, point of presence or other network device(s) (referred to generally as an instance of network infrastructure) that can provide the service. Routers and other devices on the Internet determine the best path to forward packets to one of the sites using the BGP protocol.

Providing a distributed infrastructure enables traffic loads to be shared, which can help not only with flash crowds but also with the large amounts of traffic seen in volumetric attacks, such as distributed denial of service (DDoS) attacks. To more effectively mitigate volumetric attacks, however, network “scrubbing centers” are used. Scrubbing centers are known in the art and described for example in U.S. Pat. No. 7,478,429 (titled “Network overload detection and mitigation system and method” and issued Jan. 13, 2009), the contents of which are hereby incorporated by reference in their entirety and for all purposes.

Scrubbing centers are an example of another kind of network infrastructure. Scrubbing centers are designed to ingest large amounts of traffic and, if the traffic is benign, pass it through to an endpoint (typically the origin servers and/or network of a customer of the scrubbing center service). If and when an attack is detected, the scrubbing center is designed to mitigate the attack by removing the packets suspected of belonging to the attack and pass on only “clean” traffic to the customer.

It is difficult to manage traffic and control load across multiple scrubbing centers, particularly when the scrubbing centers are handling traffic for many different customers associated with many different domains. Typically, only a subset of customers will come under attack at a given time. It is important that the scrubbing center's load be carefully managed so as to effectively thwart the attack yet minimize performance degradation for other customers, websites--in other words, limit the collateral damage. This patent document discloses improved technology to move traffic nimbly between scrubbing centers, to better contain attack traffic and mitigate collateral damage, to prevent scrubbing center overloads, and otherwise better defend against volumetric attacks.

A current technique for traffic management is the use of traffic engineering communities. But using traffic engineering communities to adjust inbound traffic can be complex and result in safety issues. For example, sending the wrong community to a provider can impact a customer's reachability. Another known technique is to use autonomous system (AS) path prepend. But that technique is not a consistently useful way to manage inbound load. Moreover, predicting where traffic will move is difficult using traffic engineering communities or AS path prepend because it is virtually impossible to pre-calculate the resulting best paths in the tables of third-party providers.

The teachings described in this patent document have particular application with respect to scrubbing centers. They are, however, not limited to managing traffic across scrubbing centers. They also apply to managing traffic across multiple servers, data centers, or other types of network infrastructure. Indeed, the teachings hereof apply to any type of network infrastructure that may be deployed in multiple instances and require traffic management or load balancing across those deployments.

The teachings presented herein improve the functioning of a computer system itself, as well as that of a larger distributed system. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of the issued patent define the scope of protection.

Systems and methods for mitigating volumetric attacks are disclosed. In many cases, when attacks are detected in a particular set of traffic, the systems and methods leverage the general obedience of non-malicious clients to follow request routing directions. Such request routing could be implemented in the form of DNS responses, policy based routing, HTTP layer redirection, or any other known technique for request or packet routing. The non-malicious traffic is instructed to move away from the current destination (such as a particular IP address or particular anycast site), the result being that much of the malicious traffic remains. In this way it is easier to block such remaining traffic. Such techniques can be used in addition to current techniques of trying to filter the malicious traffic from the non-malicious traffic.

In one embodiment, a preparatory phase prior to attack can involve configuring an IP addressing scheme to associate multiple infrastructure deployments with a group of anycasted IP prefixes, and advertising each of those anycasted IP prefixes as reachable from every deployment in the group. As mentioned earlier, an infrastructure deployment might be a scrubbing center, data center, server cluster, point of presence, or otherwise.

A customer has a domain name that will be protected or handled by the system. A DNS server answers queries for the subject domain name by providing an IP address from one of the group of anycasted IP prefixes. Preferably the selection is performed by choosing IP prefixes so as to spread the traffic load (of the ensuing client requests) across the IP prefixes. The selection algorithm can be implemented in many ways, such a round robin fashion or otherwise such that each anycast IP prefix is given a substantially equal share of the load.

An attack mitigation phase can involve defending against a detected attack by removing the targeted IP address under attack and/or IP prefix from the DNS selection pool. Hence, good traffic can be shifted away to the other addresses and/or prefixes. A given deployment that is heavily affected by the attack can further mitigate by stopping advertising of all of the group of anycasted IP prefixes. In addition, mitigation and traffic shifting can be achieved by altering the BGP advertisements or routing rules, or even ceasing all service from the IP address and/or IP prefix under attack.

In another embodiment, a preparatory phase can involve configuring an IP addressing scheme to associate multiple infrastructure deployments with a single anycast IP prefix and advertising that anycasted IP prefix as reachable from each of the deployments. In this case, a group of IP addresses all from that IP prefix are assigned to the customer. A DNS server answers queries for the domain name by providing an IP address from the anycasted IP prefix, preferably by selecting amongst several IP addresses in the IP prefix to spread the traffic load, as mentioned above.

In this embodiment, an attack mitigation phase can involve defending against a detected attack by removing the IP address that is under attack from the group of anycasted IP addresses. Again, good traffic can be shifted away. A given deployment that is heavily affected by the attack can further mitigate by stopping advertising of all of the group of anycasted IP prefix. In addition, mitigation and traffic shifting can be achieved by altering the BGP advertisements or routing rules, or even ceasing all service from the IP address and/or IP prefix under attack.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating network routing and connections on the Internet, including multiple scrubbing centers; and,

FIG. 2 is a block diagram illustrating hardware in a computer system that can be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, such as HTML, URL, XML, AJAX, CSS, HTTP, TCP/IP, and UDP, is assumed. Likewise, basic familiarity with well-known database technologies and terms, such as relational databases (RDBMS), SQL databases and queries, NoSQL databases and/or key-value approaches, is assumed.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

### Overview

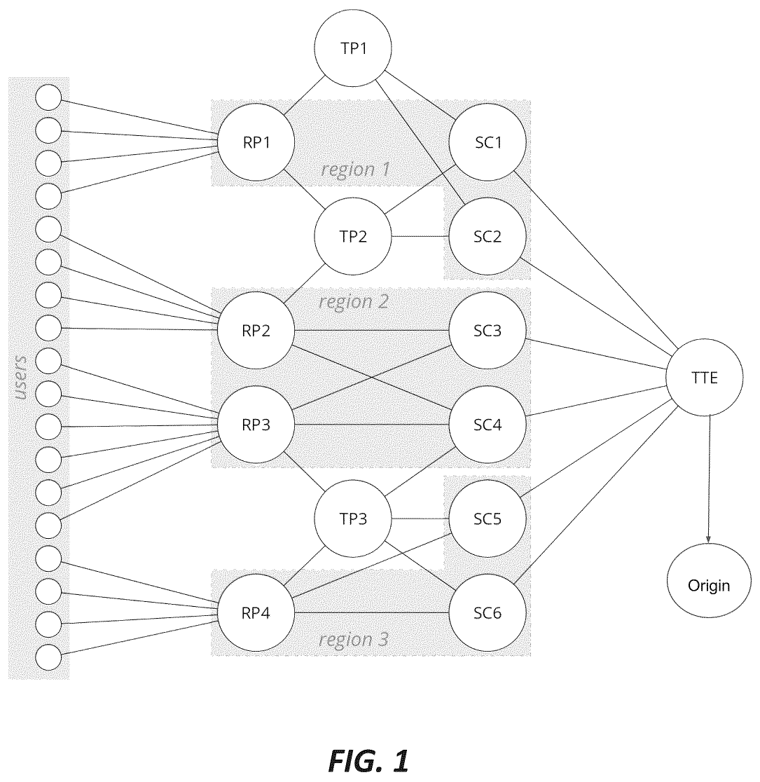

FIG. 1 illustrates a set of connections for considering inbound load control problems on the Internet. From left to right, user client devices connect through a variety of provider networks to a given origin (a server providing a website for example).

FIG. 1 illustrates several potential routes between users and origin. Regional providers (RPs) are typically ISP networks who provide connectivity for their individual subscribers upstream to the wide area network. Transit providers (TPs) offer interconnect between RPs and the larger Internet, or between regional providers that are not peered.

FIG. 1 depicts six scrubbing centers (SCs) deployed in various places in the network. Scrubbing centers are known in the art. Scrubbing centers filter traffic to remove attacks, particularly volumetric attacks, and pass on clean traffic to a customer's site or network; see for example U.S. Pat. No. 7,478,429, the teachings of which are hereby incorporated by reference. FIG. 1 illustrates six subbing center deployments SC1 to SC6, which are located in various locations around the world. After filtering, the SCs send the clean traffic to the customer site in a tunnel, typically using encapsulation through a protocol like generic routing encapsulation (GRE). The tunnel tail end (TTE) is in the customer's network, that is, where the traffic exits the tunnel and reaches the customer origin.

At a high level, the user's client devices can be directed to one of the SCs in a variety of ways. One way is to make a BGP routing change that announces the customer's origin IP address from the SCs. Packets will be routed to the SCs, where they are then tunneled to the origin. A second way is to use DNS. Client devices or their local DNS resolvers query the DNS system for the IP address associated with a domain name that is associated with the customer origin, as known in the art. The DNS system responds with an IP address pointing to a selected SC.

Considering the example of FIG. 1, assume that RPs typically support traffic engineering communities but TPs do not (which is a typical situation). As mentioned earlier in this document, using communities to adjust inbound traffic can be complex and result in customer safety issues, among other things. Using AS path prepend also has downsides.

With the foregoing context, embodiments for managing inbound load and/or mitigating volumetric attacks will now be described.

### Embodiment A

In one embodiment, a first step is to designate a group of IP prefixes that will be anycasted. Each anycast IP prefix could be a /24, for example.

A second step is to assign a given customer of the platform (and it is envisioned as a multi-tenant service) one IP address from each IP prefix. This means that client devices attempting to reach a service provided by that customer can use any of those IP addresses. The service is associated with a domain name. The customer could be providing a website under the domain name, streaming services, web applications, APIs and the like. The teachings hereof are not limited as to what the customer offers under the domain.

Third, all of the IP addresses in the group are advertised from all of the SCs in FIG. 1, that is, they are anycasted from SC1 to SC6 deployments. Generally, individual IP addresses cannot be advertised for anycast routing, so the individual IP addresses are preferably advertised by advertising the IP prefix encompassing them, generally a /24 prefix.

Fourth, a DNS server answers DNS queries for the customer's domain name by selecting one of the IP addresses in the group that was set up in steps 1 and 2. As a result, when user client devices want to reach the customer's service, they or their DNS resolver will issue a DNS query for the domain name and the DNS system will give one of the IP addresses in the group. (More specifically, the DNS resolver will query an authoritative DNS server for the answer and return the answer to the client device, caching the result for a configured time period.) Preferably the DNS system gives out the IP addresses in the group with substantially similar frequency or otherwise so that the resulting client request load is spread across the IP addresses. In one implementation, a round-robin approach can be used; however it is possible to allocate the load unevenly across the IP addresses if desired depending on the implementation.

As client devices send traffic to the anycasted IP addresses, the BGP routing tables in effect generally will direct the packet's to the closest SC. This is standard anycast operation.

Now assume a volumetric attack is detected and it targets one of the IP addresses in the group. (Note that the detection of the attack may be accomplished in any manner, the teachings hereof are agnostic as to that detection. Aforementioned U.S. Pat. No. 7,478,429 describes one way of doing so.) When the attack is detected, one or more of the following actions can be taken:
(a) Remove the IP address or its IP prefix under attack from the pool of potential DNS answers for the customer domain. This action prevents new users from connecting to the service on an address under attack.
(b) Restrict the range of the IP prefix (the prefix containing the IP address under attack) in the default free zone, moving some traffic to other SCs.
(c) Stop advertising the IP prefix (the prefix containing the IP address under attack) from the most affected SC, spreading all the attack traffic onto other SCs.
(d) If the ratio of attack versus good traffic exceeds a configured threshold (for example, more than 80%), black hole the IP address under attack. This would have some negative impact on existing client sessions, but the impact would be minimized because of the single IP address initially representing no more than 1/(group size) of the customer's traffic, and that amount will drop lower as DNS stops serving this IP address.

Despite the above changes, it is possible an attacker could “follow” the customer's IP address as DNS responses change. In this case, the attacker is still chasing a moving target, which will ultimately reduce the effectiveness of the attack.

One variant of the above technique would be initially advertising a subset of the IP addresses in the group, reserving the remaining IP addresses for future use in the case of an attack. As one IP address is attacked, drop one address from the DNS pool and add another one. If the DNS time to live on its answers is set to 0, the service can “skip” between a set of previously configured IP addresses, making it harder for an attacker to follow the service.

### EXAMPLE

An illustration of the above embodiment is now provided. First, a group of six IP addresses is chosen, each from a different/24 IP prefix. These addresses are:
192.0.1.1, 192.0.2.1, 192.0.3.1, 192.0.4.1, 192.0.5.1, and 192.0.6.1

Each IP address is represented by a /24 IP prefix in the global routing table, as follows:
192.0.1.0/24, 192.0.2.0/24, 192.0.3.0/24, 192.0.4.0/24, 192.0.5.0/25, and 192.0.6.0/24

Next, SC1 through SC6 in FIG. 1 advertise all six of these /24 IP prefixes to all their external peers.

All six of the IP addresses in the group are used to answer DNS queries for the customer's domain name in a round robin fashion. At any given time, then, roughly ⅙th of the users accessing the service will be using one of the six addresses in the group.

Assume an attacker launches a DDoS attack against IP address 192.0.1.1. When this attack is detected, 192.0.1.1 is dropped from the DNS pool, so only the five remaining addresses are used to answer queries against the customer's domain name. If the attack ultimately stops, the 192.0.1.1 address can be added back to the DNS pool, and normal operation resumes.

If the attack grows large enough to impact a particular scrubbing center's operation, let's say SC3, then BGP speakers can direct traffic away from SC3 either by restricting the scope of the BGP advertisement, or not advertising 192.0.1.0/24 as reachable through the impacted SC3. Again, as the attack drops off, advertisement and DNS entries can be restored to normal operational settings.

### Potential Advantages

The foregoing approach has several advantages. For example, an attacker targeting one of the IP addresses in the group with a DDoS attack can only impact 1/(group size) of the traffic for the domain. An attacker targeting every address in the group must either generate 1x(group size) traffic to mount an effective attack, or must spread their attack across 1x(group) destinations. In addition, inbound traffic levels can be adjusted at 1/(group size) granularity using BGP advertisement rules. And, the catchment basin for any given change in default free zone routing can be calculated using “presence of route,” rather than more complex calculations based on provider policies, and the like.

The foregoing are not requirements of or necessary to achieve in the practice of the invention, but merely a description of potential advantages that may be achieved in some implementations.

### Embodiment B

In another embodiment, a first step is to designate a group of IP addresses that will be used. The IP addresses are from the same IP prefix, preferably a /24. Any number of IP addresses could be used for purposes of illustration herein, assume that six are chosen.

A second step is to assign a given customer of the platform the six IP addresses in this group. This means that client devices attempting to reach a service provided by that customer can use any of those IP addresses. As before, the service is associated with a domain name.

Third, anycast the IP prefix containing the group of IP addresses from all of the SCs in FIG. 1. The result is that all of the IP addresses are advertised from all of the SCs shown in FIG. 1.

Fourth, a DNS server answers DNS queries for the domain name by selecting one of the IP addresses. (More specifically, an authoritative DNS server can perform this selection and resolvers can cache the results.) As before, preferably the IP addresses are given out in substantially similar frequency or otherwise so that the resulting client request load is spread across the IP addresses. In one implementation, a round-robin approach is used; however it is possible to allocate the load unevenly across the IP addresses if desired in some implementations.

Now assume a volumetric attack is detected and it targets one of the IP addresses in the group. When this attack is detected, one or more of the following actions can be taken:
(a) Remove the IP address under attack from the DNS pool of potential answers for the customer service. This action prevents new users from connecting to the service on an IP address under attack.
(b) Stop advertising the IP prefix from the most affected SC, spreading all the attack traffic onto other SCs.
(c) If the ratio of attack versus good traffic exceeds a threshold, black hole the IP address under attack. This would have some negative impact on existing sessions, but the impact would be minimized by the single IP address initially representing no more than 1/(group size) of the customer's traffic, and that amount will drop lower as DNS stops serving this IP address.

As mentioned before, variants of the above technique may involve advertising a subset of the IP addresses in the initial group to thwart attackers from following the DNS changes. Embodiment B may also provide some or all of the benefits mentioned earlier for Embodiment A.

### Other Embodiments & Variants

The teachings hereof do not rely on any specific IP prefix length. Currently, common practice is that nothing longer than an /24 IP prefix can be advertised. However, the teachings hereof are not so limited.

The teachings hereof may be used with IPv6 as well as IPv4 addressing.

It is noted that the order of steps presented in the embodiments above are not necessarily limiting.

As noted earlier in this patent document, the teachings hereof can leverage the general obedience of non-malicious clients to follow request routing directions. Such request routing is not limited to DNS responses given to client's DNS resolvers for. It could be implemented in the form of DNS responses, policy based routing, HTTP layer redirection, or any other known technique for request or packet routing.

For example, in the context of the aforementioned embodiments, if HTTP redirection were used rather than DNS alone, an HTTP server (whether at origin, in the scrubbing center, or otherwise) could be stood up to field client requests and redirect those requests to a particular domain name. When the attack is detected, the redirection could change to another domain associated with (via DNS) another set of IP addresses, thus achieving the same function as changing the pool of DNS answers that was described earlier.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

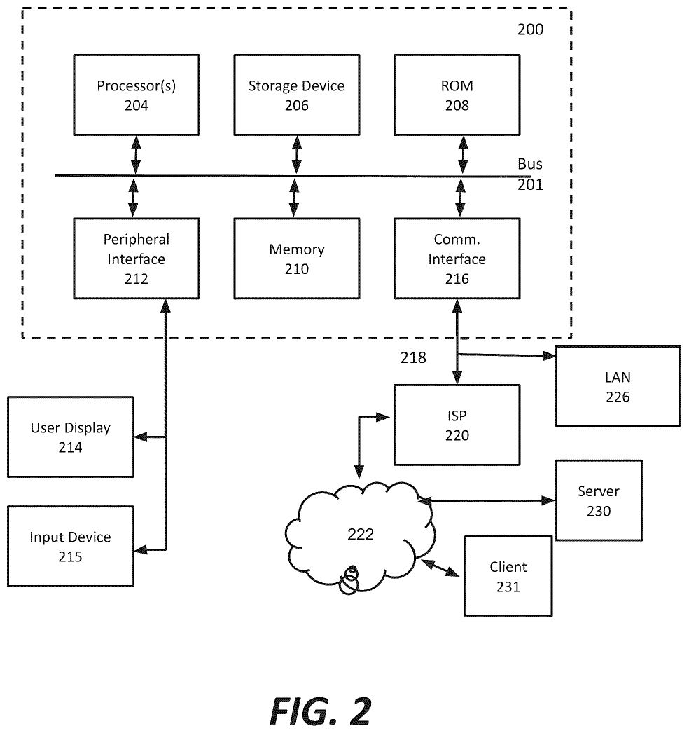

FIG. 2 is a block diagram that illustrates hardware in a computer system 200 upon which such software may run in order to implement embodiments of the invention. The computer system 200 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 200 includes a microprocessor 204 coupled to bus 201. In some systems, multiple processor and/or processor cores may be employed. Computer system 200 further includes a main memory 210, such as a random access memory (RAM) or other storage device, coupled to the bus 201 for storing information and instructions to be executed by processor 204. A read only memory (ROM) 208 is coupled to the bus 201 for storing information and instructions for processor 204. A non-volatile storage device 206, such as a magnetic disk, solid state memory (e.g., flash memory), or optical disk, is provided and coupled to bus 201 for storing information and instructions. Other application-specific integrated circuits (ASICs), field programmable gate arrays (FPGAs) or circuitry may be included in the computer system 200 to perform functions described herein.

A peripheral interface 212 may be provided to communicatively couple computer system 200 to a user display 214 that displays the output of software executing on the computer system, and an input device 215 (e.g., a keyboard, mouse, trackpad, touchscreen) that communicates user input and instructions to the computer system 200. However, in many embodiments, a computer system 200 may not have a user interface beyond a network port, e.g., in the case of a server in a rack. The peripheral interface 212 may include interface circuitry, control and/or level-shifting logic for local buses such as RS-485, Universal Serial Bus (USB), IEEE 1394, or other communication links.

Computer system 200 is coupled to a communication interface 216 that provides a link (e.g., at a physical layer, data link layer,) between the system bus 201 and an external communication link. The communication interface 216 provides a network link 218. The communication interface 216 may represent an Ethernet or other network interface card (NIC), a wireless interface, modem, an optical interface, or other kind of input/output interface.

Network link 218 provides data communication through one or more networks to other devices. Such devices include other computer systems that are part of a local area network (LAN) 226. Furthermore, the network link 218 provides a link, via an internet service provider (ISP) 220, to the Internet 222. In turn, the Internet 222 may provide a link to other computing systems such as a remote server 230 and/or a remote client 231. Network link 218 and such networks may transmit data using packet-switched, circuit-switched, or other data-transmission approaches.

In operation, the computer system 200 may implement the functionality described herein as a result of the processor executing code. Such code may be read from or stored on a non-transitory computer-readable medium, such as memory 210, ROM 208, or storage device 206. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 218 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method of mitigating volumetric attacks, comprising:
providing two or more deployments of network infrastructure that receive network packets from client devices on a wide area network;
prior to a volumetric attack, associating a domain name with a plurality of anycast IP prefixes;
advertising all of the plurality of anycast IP prefixes as reachable from all of the two or more deployments of network infrastructure;
for DNS queries received to resolve the domain name, providing an answer by selecting an IP address from one of the plurality of anycast IP prefixes such that traffic load associated with the domain name is spread across the plurality of anycast IP prefixes;
upon detection of the volumetric attack, which is directed to a particular IP address in one of the plurality of anycast IP prefixes (“attacked IP address”), withdrawing the attacked IP address from consideration in said selection when providing answers to DNS queries for the domain name, such that traffic load associated with the domain name is directed to IP addresses in the plurality of anycast IP prefixes other than the anycast IP prefix for the attacked IP address.

2. The method of claim 1, further comprising, upon detection of an overload condition at a particular one of the two or more deployments of network infrastructure:
withdrawing the advertisement of the anycast IP prefix for the attacked IP address as reachable from the particular one of the deployments of network infrastructure.

3. The method of claim 1, wherein providing an answer by selecting an IP address from one of the plurality of anycast IP prefixes comprises:
selecting each of the anycast IP prefixes with the same frequency.

4. The method of claim 1, wherein providing an answer by selecting an IP address from one of the plurality of anycast IP prefixes comprises:
selecting round robin amongst the plurality of anycast IP prefixes.

5. The method of claim 1, wherein each of the plurality of anycast IP prefixes comprises a /24 CIDR block.

6. The method of claim 1, wherein the plurality of anycast IP prefixes comprises six or more anycast IP prefixes.

7. The method of claim 1, wherein the two or more deployments of network infrastructure comprise two or more scrubbing centers.

8. The method of claim 1, wherein the domain name is associated with a customer of a volumetric attack protection service provided by the two or more deployments of network infrastructure.

9.-16. (canceled)

17. A system comprising circuitry forming a plurality of processors and one or more memories holding computer program instructions for execution on the plurality of processors to operate the system to:
provide two or more deployments of network infrastructure that receive network packets from client devices on a wide area network;
prior to a volumetric attack, associate a domain name with a plurality of anycast IP prefixes;
advertise all of the plurality of anycast IP prefixes as reachable from all of the two or more deployments of network infrastructure;
for DNS queries received to resolve the domain name, provide an answer by selecting an IP address from one of the plurality of anycast IP prefixes such that traffic load associated with the domain name is spread across the plurality of anycast IP prefixes;
upon detection of the volumetric attack, which is directed to a particular IP address in one of the plurality of anycast IP prefixes (“attacked IP address”), withdraw the attacked IP address from consideration in said selection when providing answers to DNS queries for the domain name, such that traffic load associated with the domain name is directed to IP addresses in the plurality of anycast IP prefixes other than the anycast IP prefix for the attacked IP address.

18.-19. (canceled)

20. A non-transitory computer readable medium storing program instructions for execution on one or more hardware processors, the program instructions comprising instructions for:
providing two or more deployments of network infrastructure that receive network packets from client devices on a wide area network;
prior to a volumetric attack, associating a domain name with a plurality of anycast IP prefixes;
advertising all of the plurality of anycast IP prefixes as reachable from all of the two or more deployments of network infrastructure;
for DNS queries received to resolve the domain name, providing an answer by selecting an IP address from one of the plurality of anycast IP prefixes such that traffic load associated with the domain name is spread across the plurality of anycast IP prefixes;
upon detection of the volumetric attack, which is directed to a particular IP address in one of the plurality of anycast IP prefixes (“attacked IP address”), withdrawing the attacked IP address from consideration in said selection when providing answers to DNS queries for the domain name, such that traffic load associated with the domain name is directed to IP addresses in the plurality of anycast IP prefixes other than the anycast IP prefix for the attacked IP address.

21.-22. (canceled)

18. The system of claim 17, one or more memories holding computer program instructions for execution on the plurality of processors to operate the system to: upon detection of an overload condition at a particular one of the two or more deployments of network infrastructure: withdraw the advertisement of the anycast IP prefix for the attacked IP address as reachable from the particular one of the deployments of network infrastructure.

19. The system of claim 17, wherein providing an answer by selecting an IP address from one of the plurality of anycast IP prefixes comprises:
selecting each of the anycast IP prefixes with the same frequency.

20. The system of claim 17, wherein providing an answer by selecting an IP address from one of the plurality of anycast IP prefixes comprises:
selecting round robin amongst the plurality of anycast IP prefixes.

21. The system of claim 17, wherein each of the plurality of anycast IP prefixes comprises a /24 CIDR block.

22. The system of claim 17, wherein the plurality of anycast IP prefixes comprises six or more anycast IP prefixes.

23. The system of claim 17, wherein the two or more deployments of network infrastructure comprise two or more scrubbing centers.

24. The system of claim 17, wherein the domain name is associated with a customer of a volumetric attack protection service provided by the two or more deployments of network infrastructure.
